(19) United States
(12) Patent Application Publication
(10) Pub. No.: US 2011/0253174 A1
(43) Pub. Date: Oct. 20, 2011

(54) METHOD FOR DECONTAMINATING SEMICONDUCTOR WAFERS

(75) Inventors: Christophe Martin, Aix En Provence (FR); Sëbastien Collura, Istres (FR)

(73) Assignee: STMicroelectronics (Rousset) SAS, Rousset (FR)

(21) Appl. No.: 13/075,427

(22) Filed: Mar. 30, 2011

(30) Foreign Application Priority Data
Apr. 20, 2010 (FR) 10/52977

(51) Int. Cl. B08B 7/04

(52) U.S. Cl. 134/18

(57) ABSTRACT

A method for decontaminating at least one object contained in a chamber, the method including a succession of alternated steps of lowering and increasing the pressure in the chamber.

### CROSS REFERENCE TO RELATED APPLICATIONS

This application claims the priority benefit of French patent application number 10/52977, filed on Apr. 20, 2010, entitled “METHOD FOR DECONTAMINATING SEMICONDUCTOR WAFERS,” which is hereby incorporated by reference to the maximum extent allowable by law.

### BACKGROUND OF THE INVENTION

1. Field of the Invention

The present invention relates to a method for decontaminating semiconductor wafers. It more specifically aims at the decontamination of wafers likely to have adsorbed corrosive gases in steps of forming of conductive copper or aluminum interconnection tracks and vias.

2. Discussion of the Related Art

Conventionally, integrated circuit manufacturing methods comprise steps of conductive copper or aluminum interconnection track and via forming, at the surface of semiconductor wafers, for example, silicon wafers. The forming of such tracks and vias especially comprises successive steps of deposition and etching of metal layers and of insulating layers. In the etch steps, especially the plasma etch steps, various contaminating elements may be produced and adsorbed, for example, in the insulating layers of the interconnection stack. The presence of such contaminating elements in the wafers may result, later on, in a deterioration of the integrated circuits.

A step of wafer decontamination after the forming of the conductive tracks and vias is currently provided.

A decontamination method comprising placing the wafers in vacuum for a relatively long time to extract the contaminating elements adsorbed during etch operations has been provided. To achieve this, at the end of the manufacturing, the wafers are placed in transfer and processing containers, each container containing a large number of wafers. Such containers are generally designated as “pods” or FOUP (“Front Opening Unified Pod”) in the art. One or several pods are placed in a decontamination chamber. The decontamination chamber is then set to a pressure much lower than the atmospheric pressure, for example, a pressure lower than 10⁻³ mPa. The chamber will be said to be vacuumized.

A disadvantage of such a method is that, to obtain a satisfactory result, the pods should stay in the decontamination chamber for a long time, for example, on the order of 60 min.

It would be desirable to have faster wafer decontaminating means.

To accelerate the contaminating element elimination process, it has been suggested to heat the wafers during the decontamination. Indeed, the diffusion speed of contaminating elements increases along with temperature. However, in practice, it is very difficult to heat the wafers satisfactorily. Indeed, due to the very low pressure in the decontamination chamber, convection heating is impossible. Further, the arrangement of the wafers, which are stacked in pods, forbids heating by infrared radiation. Similarly, conduction heating is not very efficient since only a small portion of the wafer surface is in direct contact with the pods.

A decontamination method comprising placing the wafers in storage cabinets under a low-pressure flow of nitrogen or another inert gas has also been provided. The storage under a nitrogen flow especially enables avoiding any corrosion due to the contaminating elements. However, the decontamination time is then very long. Further, such a method induces unwanted nitrogen consumption.

### SUMMARY OF THE INVENTION

Thus, an object of an embodiment is to provide a method for decontaminating semiconductor wafers at least partly overcoming some of the disadvantages of prior art solutions.

Another object of an embodiment is to provide such a method enabling a faster wafer decontamination than existing solutions.

Another object of an embodiment is to provide such a method which is easy to implement, and especially easy to implement by using existing decontamination equipment.

Thus, an embodiment provides a method for decontaminating at least one object contained in a chamber, this method comprising a succession of alternated steps of lowering and increasing the pressure in the chamber.

According to an embodiment, said at least one object is a semiconductor wafer.

According to an embodiment, in pressure increase steps, a gas previously heated to a temperature greater than the ambient temperature is injected into the chamber.

According to an embodiment, this temperature ranges between 40 and 90° C.

According to an embodiment, the pressure lowering and increase steps are repeated from 3 to 15 times each.

According to an embodiment, in pressure lowering steps, the pressure in the chamber is lowered down to a low value smaller than 10⁻³ mPa.

According to an embodiment, in pressure increase steps, the pressure in the chamber is increased up to a high value ranging from 30 to 100 percent of the atmospheric pressure.

According to an embodiment, in pressure increase steps, nitrogen is injected into the chamber.

According to an embodiment of the present invention, each cycle comprising a pressure lowering step and a pressure increase step, consecutive to the lowering step, has a duration ranging from 3 to 10 minutes.

According to an embodiment, at the end of each pressure lowering step, the pressure in the chamber is maintained at a low value for a time interval shorter than 2 minutes.

The foregoing objects, features, and advantages will be discussed in detail in the following non-limiting description of specific embodiments in connection with the accompanying drawings.

### BRIEF DESCRIPTION OF THE DRAWINGS

FIG. 1 is a cross-section view very schematically showing an example of a semiconductor wafer decontamination chamber;

FIG. 2 is a diagram schematically showing steps of an embodiment of a semiconductor wafer decontamination method; and

FIG. 3 is a diagram schematically showing an alternative embodiment of the method of FIG. 2.

### DETAILED DESCRIPTION

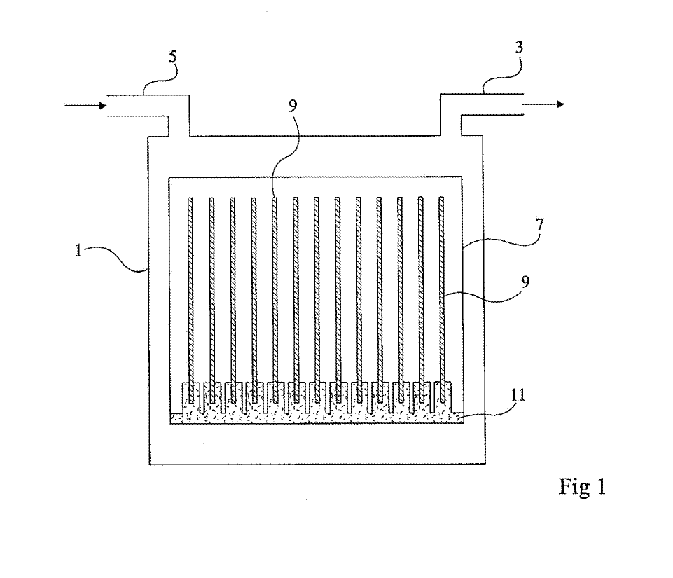

For clarity, the same elements have been designated with the same reference numerals in the different drawings and, further, FIG. 1 is not drawn to scale.

FIG. 1 is a cross-section view very schematically showing an example of a semiconductor wafer decontamination chamber 1. This equipment is conventionally used to implement the above-mentioned decontamination method, where the wafers are placed in vacuum for a relatively long time. Chamber 1 is a tight enclosure into which emerge a gas mixture intake nozzle 3 and injection nozzle 5. Nozzle 3 is, for example, connected to a vacuum pump (not shown). Nozzle 5 enables injecting, into the chamber a gas, for example, air, to restore a pressure close to the atmospheric pressure at the end of the decontamination process. Nozzles 3 and 5 are provided with tight closing valves (not shown). In this example, chamber 1 contains a pod 7 in which semiconductor wafers 9 are arranged. In pod 7, a support 11 enables to maintain wafers 9 parallel to one another and facing each other two by two. Thus, the wafers, for example by the number of 25, are stacked, with a free space separating the wafers from one another. Pod 7 comprises openings enabling the pressure within pod 7 to balance with the pressure in chamber 1.

The present inventors have observed that an alternation of steps of lowering and increase of the pressure in the decontamination chamber results in a faster elimination of the contaminating elements than a maintaining of the wafers at constant pressure, even very low. This is especially due to the fact that pressure variations in the decontamination chamber cause an increase in the contaminant concentration gradient, thus promoting the diffusion contaminating elements.

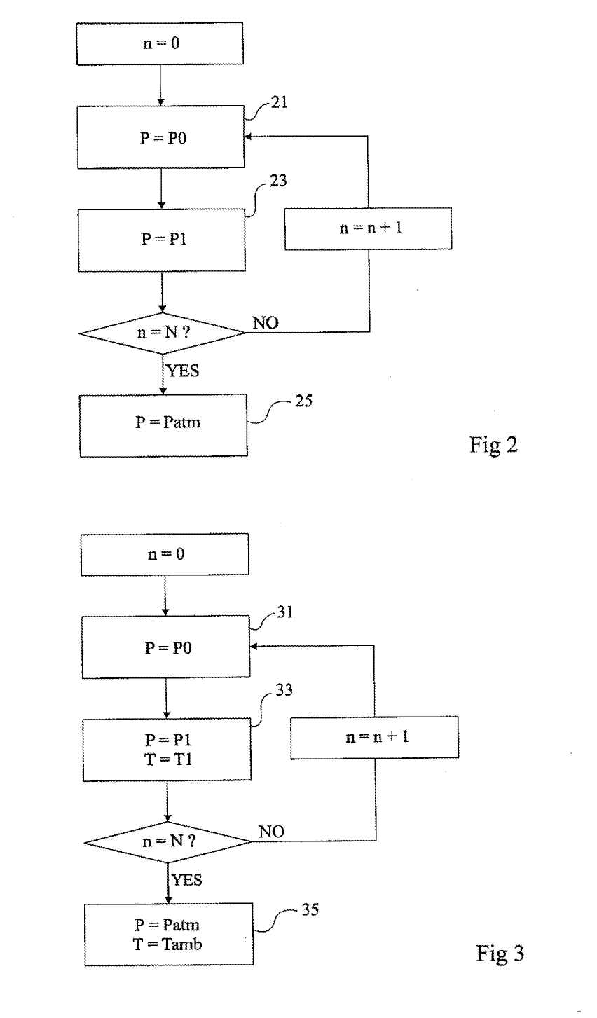

FIG. 2 is a diagram schematically showing steps of an example of a method for decontaminating semiconductor wafers. As described hereabove, the wafers are arranged in pods, and one or several pods are placed in a decontamination chamber of the type described in relation with FIG. 1. Initially, the pressure in the decontamination chamber is approximately equal to the atmospheric pressure.

In a step 21, pressure P in the decontamination chamber is taken down to a low value P0, for example, lower than 10⁻³ mPa. The pressure in the decontamination chamber may be maintained at low value P0 for some time, for example, from 0 seconds to 2 minutes.

In a step 23 following step 21, pressure P in the decontamination chamber is taken up to a high value P1 greater than P0. As an example, high value P1 may range between 30 and 100% of the atmospheric pressure. The restoring of pressure P to a value greater than P0 may be obtained by injecting a gas mixture, for example, air, nitrogen, or another inert gas or gas mixture (argon, helium, etc.), via nozzle 5.

When high value P1 has been reached, the pressure in the decontamination chamber is lowered back to P0 (step 21). Steps 21 and 23 are alternately repeated N times, N being an integer, for example ranging between 3 and 15. At the end of the process, in a step 25, pressure P in the decontamination chamber is taken back to the atmospheric pressure Patm.

Although they comprise pressure-balancing ports, pods 7 (FIG. 1) are provided to maintain the wafers in a relatively confined atmosphere. Indeed, such pods are especially used, in the transfer of the wafers from one piece of equipment to another, to protect the wafers against possible contaminations by outer particles (dust, etc.). The pressure variations in the decontamination chamber should thus be progressive and sufficiently slow to avoid that the pods explode or implode. As an example, each cycle of lowering/restoring of the pressure in the chamber may last from 3 to 10 minutes, the number of cycles being selected according to the cycle duration so that the total decontamination time is much shorter than one hour. To be able to more rapidly lower/restore the pressure, it may be provided to use pods having wide openings, or to maintain the pods open. In this case, it will be ascertained that parasitic particles do not risk contaminating the wafers.

An advantage of the provided method is that it enables decontaminating the wafers faster than when they are maintained in vacuum at constant pressure. Another advantage of this method is that it can easily be implemented by using a conventional vacuum decontamination chamber, of the type described in relation with FIG. 1.

The present inventors have observed that the method described in relation with FIG. 2 results in a decrease on the order of 40% of the decontamination time with respect to the conventional solution where the wafers are maintained in vacuum, at constant pressure and temperature.

As an example, number N of pressure lowering/restoring cycles may be set to 5, low pressure P0 may be equal to 5*10⁻⁴ mPa, high pressure P1 may be equal to the atmospheric pressure, and the duration of each cycle may be equal to 7 min, including maintaining of the chamber at low pressure P0 for 1 min. With such parameters, resulting in a total decontamination time of 35 min, the present inventors have obtained a decontamination level equivalent to that obtained by maintaining the wafers in vacuum for 60 min.

FIG. 3 is a diagram schematically showing an alternative embodiment of the decontamination method described in relation with FIG. 2. As in the method of FIG. 2, initially, the pressure in the decontamination chamber is approximately equal to the atmospheric pressure. Further, temperature T in the decontamination chamber is approximately equal to the ambient temperature (temperature outside of the decontamination chamber), that is, for example, ranging between 15 and 30° C.

In a step 31, corresponding to step 21 of FIG. 2, pressure P in the decontamination chamber is taken down to a low value P0.

In a step 33, following step 31, corresponding to step 23 of FIG. 2, pressure P in the decontamination chamber is taken back to a high value P1 greater than P0. In this embodiment, the gas, for example air or nitrogen, introduced into the chamber to increase pressure P, has been previously heated up to a temperature T1 greater than the ambient temperature. As an example, temperature T1 ranges between 40 and 90° C. It should be noted that temperature T1 may take any other adapted value. This value will be preferably selected to be relatively high, but of course sufficiently low to avoid damaging the elements which are desired to be decontaminated.

As in the method of FIG. 2, steps 31 and 33 are alternately repeated N times. At the end of the process, in a step 35, pressure P in the decontamination chamber is taken back to atmospheric pressure Patm.

An advantage of this embodiment is that it enables heating the semiconductor wafers by convection, by introducing a hot gas into the chamber on each occurrence of pressure restoring step 33. This enables accelerating the diffusion of the contaminating gases. Such a heating of the wafers is, as discussed previously, impossible to obtain with the conventional method where the wafers are maintained in vacuum for a long time.

Specific embodiments of the present invention have been described. Various alterations and modifications will occur to those skilled in the art.

In particular, a method for decontaminating semiconductor wafers having adsorbed contaminating elements after chemical etch operations has been described herein. The present invention is not limited to this specific case. It will be within the abilities of those skilled in the art to implement the provided method to decontaminate any device (wafer, container, wafer transport box, photolithography mask, or other) that may have adsorbed contaminating elements, whatever the contamination source.

Further, the provided method comprises an alternation of steps of pressure decrease in the decontamination chamber down to a low pressure P0, and of pressure increase in the decontamination chamber up to a high pressure P1 greater than P0. The values mentioned hereabove for low and high pressures P0 and P1 have been given as an example only. The present invention is not limited to these specific cases. It should be noted that, should the equipment allow it, low pressure P0 may be lower than 10⁻⁴ mPa and high pressure P1 may be greater than the atmospheric pressure. It may further be chosen to modify low and high values P0 and P1 of the pressure in the chamber each time the cycle is repeated.

Similarly, the above-mentioned numerical values for temperature T1 to which the decontamination chamber is heated, for number N of cycles, for the cycle duration, and for the time for which the chamber is maintained at low pressure P0, have been given as an example only.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A method for decontaminating at least one object contained in a chamber, the method comprising a succession of alternated steps of lowering and increasing the pressure in the chamber, wherein, in pressure increasing steps, a gas previously heated to a temperature greater than the ambient temperature is injected into the chamber.

2. The method of claim 1, wherein said at least one object is a semiconductor wafer.

3. The method claim 2, wherein said temperature ranges between 40 and 90° C.

4. The method of claim 1, wherein the pressure lowering and increasing steps are repeated from 3 to 15 times each.

5. The method of claim 1, wherein in pressure lowering steps, the pressure in the chamber is lowered down to a low value smaller than 10⁻³ mPa.

6. The method of claim 1, wherein in pressure increasing steps, the pressure in the chamber is increased up to a high value ranging from 30 to 100 percent of the atmospheric pressure.

7. The method of claim 1, wherein in pressure increasing steps, nitrogen is injected into the chamber.

8. The method of claim 1, wherein each cycle comprising a pressure lowering step and a pressure increasing step consecutive to the lowering step, has a duration ranging from 3 to 10 minutes.

9. The method of claim 1, wherein at an end of each pressure lowering step, the pressure in the chamber is maintained at a low value for a time interval shorter than 2 minutes.
